(19) United States
(12) Patent Application Publication
(10) Pub. No.: US 2006/0285014 A1
(43) Pub. Date: Dec. 21, 2006

(54) Digital broadcasting signal processing apparatus and control method thereof

(75) Inventor: Duk-jin Kang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/410,031

(22) Filed: Apr. 25, 2006

(30) Foreign Application Priority Data
Jun. 16, 2005 (KR) 2005-0052085

(51) Int. Cl. H04N 5/45

(52) U.S. Cl. 348/565

(57) ABSTRACT

A digital broadcasting signal processing apparatus having a direct channel change (DCC) function, including a signal processor; and a controller to control the signal processor to output first channel information if a first channel is changed into a second channel by the DCC function. Thus, a digital broadcasting signal processing apparatus can display information on an original channel before a channel changed by a direct channel change (DCC) function returns to the original channel so that a user selects to return to the original channel without difficulty.

### CROSS-REFERENCE TO RELATED APPLICATIONS

This application claims the benefit under 35 U.S.C. § 119 of Korean Patent Application No. 2005-0052085, filed on Jun. 16, 2005, in the Korean Intellectual Property Office, the disclosure of which is incorporated herein by reference.

### BACKGROUND OF THE INVENTION

1. Field of the Invention

The present invention relates to a digital broadcasting signal processing apparatus, and more particularly, to a digital broadcasting signal processing apparatus in which a user selects returning to an original channel without difficulty after a channel of the digital broadcasting signal processing apparatus is changed by a direct channel change (DCC) function.

2. Description of the Related Art

Generally, a digital broadcasting signal processing apparatus receives a digital video signal, a digital audio signal and a digital data signal which are compressed. The digital data signal comprises program information; and program and system information protocol (PSIP).

The PSIP are standards for advanced television system committee (ATSC) of terrestrial and cable digital TVs. The PSIP comprise a master guide table (MGT), a virtual channel table (VCT), an event information table (EIT), an extended time table (ETT), a rating region table (RRT) and a system time table (STT). The PSIP further comprise a direct channel change table (DCCT) and a direct channel change selection code table (DCCSCT) as extended standards to support the DCC function.

If a viewer sets desired items in advance while the DCC function is enabled, a viewer may view program content satisfying preset conditions without searching desired broadcasting channels. That is, a channel displayed on a display part is automatically changed by the DCC function without a viewer's additional adjustment. Upon reaching a predetermined returning point of time, the changed channel returns to an original channel.

However, in a conventional digital broadcasting signal processing apparatus, when the changed channel goes back to the original channel by the DCC function, the original channel may offer program content that a viewer does not want to view.

### SUMMARY OF THE INVENTION

Accordingly, it is an aspect of the present invention to provide a digital broadcasting signal processing apparatus which displays information on an original channel before a channel changed by a direct channel change (DCC) function returns to the original channel so that a user selects to return to the original channel without difficulty.

Additional aspects and/or advantages of the present invention will be set forth in part in the description which follows and, in part, will be obvious from the description, or may be learned by practice of the present invention.

The foregoing and/or other aspects of the present invention are also achieved by providing a digital broadcasting signal processing apparatus having a direct channel change (DCC) function, comprising a signal processor; and a controller to control the signal processor to output first channel information if a first channel is changed into a second channel by the DCC function.

According to an aspect of the present invention, the digital broadcasting signal processing apparatus further comprises a display part, wherein the signal processor outputs the image signal and the first channel information to the display part.

According to an aspect of the present invention, the digital broadcasting signal processing apparatus further comprises a signal receiver to receive information on a changing point of time at which a channel displayed on the display part by the DCC function is changed from the first channel to the second channel, and information on a returning point of time at which the second channel displayed on the display part returns to the first channel, wherein the controller controls the display part to display the first channel information at a display point of time which is ahead of predetermined time from the returning point of time.

According to an aspect of the present invention, the signal receiver receives a direct channel change table (DCCT) comprising information on the changing point of time and the returning point of time.

According to an aspect of the present invention, the controller controls the signal processor to display an image displayed on the first channel at the display point of time, on a part of the display part.

According to an aspect of the present invention, the controller controls the display part to display the first channel information thereon for predetermined periods of time starting from the display point of time.

According to an aspect of the present invention, the controller controls the display part to display the second channel thereon by a predetermined control signal even after the returning point of time.

According to an aspect of the present invention, the controller enables the control signal only when the first channel information is displayed on the display part.

According to an aspect of the present invention, the digital broadcasting signal processing apparatus further comprises a user input part to generate the control signal.

According to an aspect of the present invention, the signal processor further comprises an interface generator to generate an interface image to notify a user that the channel displayed on the display part returns to the first channel if reaching the returning point of time, and the controller controls the interface generator to display the interface image on the display part before the predetermined time from the returning point of time.

The foregoing and/or other aspects of the present invention are also achieved by providing a method of controlling a digital broadcasting signal processing apparatus having a direct channel change (DCC) function, comprising changing a first channel into a second channel by the DCC function; and outputting the first channel information.

According to an aspect of the present invention, the method further comprises displaying the first channel information.

According to an aspect of the present invention, a method of controlling the digital broadcasting signal processing apparatus further comprises receiving information on a changing point of time at which the first channel is changed into the second channel by the DCC function, wherein displaying the first channel information comprises displaying the first channel information on the display part at a display point of time which is ahead of predetermined time from the returning point of time.

According to an aspect of the present invention, in the method of controlling a digital broadcasting apparatus the information on the changing point of time and the returning point of time is included in a direct channel change table (DCCT) to be received.

According to an aspect of the present invention, in the method of controlling a digital broadcasting apparatus the displaying the first channel information comprises displaying an image displayed on the first channel at the display point of time, on a part of the display part.

According to an aspect of the present invention, in the method of controlling a digital broadcasting apparatus the image displayed on the first channel is displayed on the part of the display part for predetermined periods of time starting from the display point of time.

According to an aspect of the present invention, in the method of controlling a digital broadcasting apparatus the digital broadcasting signal processing apparatus further comprises receiving a predetermined control signal and displaying the second channel on the display part by the control signal even after the returning point of time.

According to an aspect of the present invention, in the method of controlling a digital broadcasting apparatus the control signal is enabled only when the image displayed on the first channel is displayed on the part of the display part.

According to an aspect of the present invention, the digital broadcasting signal processing apparatus further comprises displaying an interface image on the display part to notify a user that the channel displayed on the display part returns to the first channel if reaching a returning point of time, before the predetermined time from the returning point of time.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a control block diagram of a digital broadcasting signal processing apparatus according to an exemplary embodiment of the present invention;

FIG. 2 is an image displayed on a display part according to an exemplary embodiment of the present invention; and

FIG. 3 is a control flowchart of the digital broadcasting signal processing apparatus according to an exemplary embodiment of the present invention.

### DETAILED DESCRIPTION OF THE ILLUSTRATIVE, NON-LIMITING EMBODIMENTS OF THE INVENTION

Reference will now be made in detail to the exemplary embodiments of the present invention, examples of which are illustrated in the accompanying drawings, wherein like reference numerals refer to like elements throughout. The described exemplary embodiments are intended to assist the understanding the invention, and are not intended to limit the invention in any way.

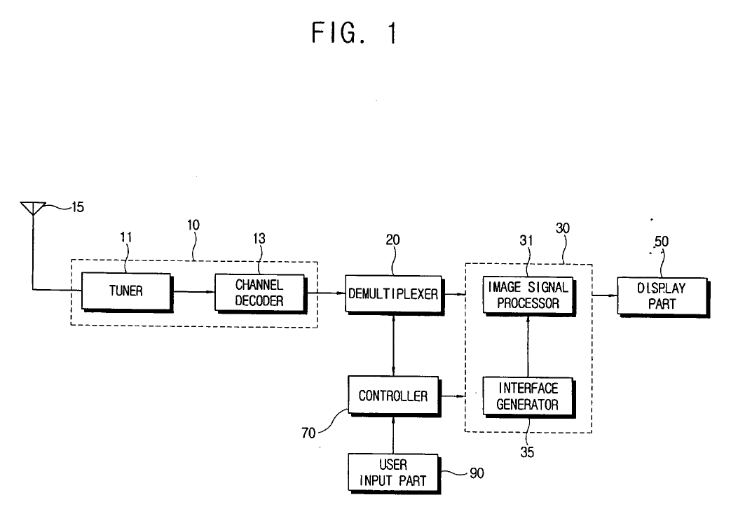

As shown in FIG. 1, a digital broadcasting signal processing apparatus according to an exemplary embodiment of the present invention comprises an antenna 15; a signal receiver 10 to receive a digital broadcast signal through the antenna 15; a demultiplexer 20 to divide the broadcast signal received from the signal receiver 10; a signal processor 30; a speaker 40 to output sound; a display part 50 to display an image thereon; a memory 60; and a controller 70 to control the foregoing elements. The digital broadcasting signal processing apparatus may further comprise a user input part 90.

The digital broadcast signal is transmitted as a transport stream in which the digital video signal, the digital audio signal and the digital data information are multiplexed in a time division manner and packeted.

The signal receiver 10 receives the broadcast signal from the antenna 15. The signal receiver 10 comprises a tuner 11 and a channel decoder 13. The tuner 11 tunes the broadcast signal received through the antenna 15 into a broadcast signal having a frequency band corresponding to a tuning control signal of the controller 70 (to be described later).

That is, the tuner 11 selects the broadcast signal corresponding to the channel to be displayed on the display part 50 among a plurality of broadcast signals received through the antenna 15, and outputs it to the channel decoder 13. Then, the channel decoder 13 restores the digital broadcast signal detected from the broadcast signals received from the tuner 11 by packet, and outputs it to the demultiplexer 20.

The demultiplexer 20 divides the digital audio signal, the digital video signal and the digital data information of the digital broadcast signal in the restored packet, into individual bit rows and outputs them to a video signal processor 31, an audio signal processor 33 and a data processor (not shown), respectively. Here, the data processor may be included in the controller 70. Hereinafter, the controller 70 will be explained as the data processor.

The data information comprises program and system information protocol (PSIP) data. The PSIP data comprise a directed channel change table (DCCT) for the DCC function.

TABLE

| Syntex | Bits | Format |
|---|---|---|
| directed_channel_change_table_section( ){ | | |
| table_id | 5 | OxD3 |

. . .

| | | |
|---|---|---|
| dcc_from_major_channel_number | 10 | uimsbf |
| dcc_from_minor_channel_number | 10 | uimsbf |
| reserved | 4 | ‘1111’ |
| dcc_to_major_channel_number | 10 | uimsbf |
| dcc_to_minor_channel_number | 10 | uimsbf |
| dcc_start_time | 32 | uimsbf |
| dcc_end_time | 32 | uimsbf |
| dcc_term_count | 8 | uimsbf |
| For(j=0<dcc_term_count; j++){ | | |
| Dcc_selection_type | 8 | uimsbf |
| Dcc_selection_id | 64 | uimsbf |

. . .

| | | |
|---|---|---|
| CRC_32 | 32 | rpchof |
| } | | |

Here, the DCCT has a structure like the foregoing table.

If the digital broadcasting signal processing apparatus according to an exemplary embodiment of the present invention receives the DCCT while the DCC function is enabled by a user's selection, etc., the channel is changed as follows.

When a viewer views a first channel (dcc_from_major_channel_number, dcc_from_minor_channel_number), if selection information (dcc_selection_id of dcc_selection_type) of the DCCT conforms to user information (e.g. sex, region, age, favorite genres) set by a user, the channel displayed on the display part 50 is changed into a second channel (dcc_to_major_channel_number, dcc_to_minor_channel_number) at a change point of time (dcc_start_time) and returns to a first channel (i.e., the original channel) at a returning point of time (dcc_end_time).

If a user selects to move to the first channel or a third channel before returning to the first channel, or the table (dcc_selection_type=O×OF) to stop the DCC function is supplied, the DCC function is disabled.

The signal processor 30 comprises a video signal processor 31 and an interface generator 35.

The video signal processor 31 processes the broadcast signal divided from the demultiplexer 20, and converts the video signal of the divided broadcast signals into a signal displayable by the display part 50 to provide it to the display part 50.

The interface generator 35 generates a predetermined interface image to be displayed on the display part 50.

The display part 50 comprises a display module (not shown) to display an image thereon; and a module driver (not shown) to process the video signal input from the signal processor 30 and to display it on the display module. The display module according to an exemplary embodiment of the present invention may include a digital light processing (DLP), a liquid crystal display (LCD), a plasma display panel (PDP), etc.

If the display module is provided as the DLP, the module driver may comprise an optical engine. If the display module is provided as the LCD, the module driver may comprise a printed circuit board (PCB) which changes the signal input from the signal processor 30 into a data signal and a gate signal. The respective display parts 50 may comprise a module driver corresponding to types of the display module.

The user input part 90 is provided to input or select a predetermined function by a user. The user input part 90 may comprise a plurality of input keys, buttons, etc. The user input part 90 may comprise a remote controller.

Here, the user input part 90 may further comprise a stop key to stop the channel displayed on the display part 50 from returning to the first channel at a returning point of time. The stop key may be exclusively provided to stop the channel displayed from returning to the first channel, but not limited thereto. Alternatively, an exit key, which is provided in the remote controller, may stop the channel displayed on the display part 50 returning to the first channel under predetermined conditions.

The controller 70 controls the display part 50 to display first channel information when the channel is changed into the second channel by the DCC function at a changing point of time while a viewer views the first channel. Specifically, the controller 70 determines whether a display point of time is reached, which is ahead of predetermined time from the returning point of time. If determined that the predetermined display point of time is reached, the controller 70 controls the display part 50 to display the first channel information thereon.

At this time, the digital broadcasting signal processing apparatus according to an exemplary embodiment of the present invention may control the signal processor 30 to display the first channel information on a part of the display part 50.

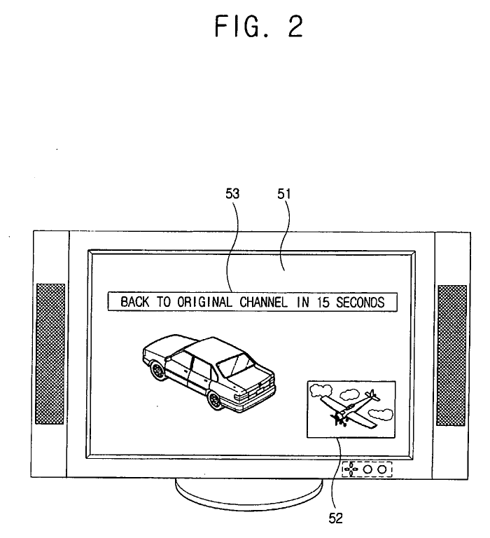

For example, if the digital broadcasting signal processing apparatus according to an exemplary embodiment of the present invention comprises a plurality of tuners, the controller 70 may control the tuner 11 and the signal processor 30 to display the second channel currently being displayed on the display part 50 as a first image, to display the first channel to be displayed on the display part 50 after the returning point of time as a second image. The second channel may be displayed on the display part 50 as a main image 51 (refer to FIG. 2), and the first channel may be displayed on the display part 50 as a sub image 52 (refer to FIG. 2). Also, the controller 70 may control the interface generator 35 to display a predetermined interface image comprising the first channel information, on the display part 50.

As described above, the controller 70 may control the display part 50 to display information on titles, genres, etc. of the program content aired on the first channel, as well as to display the image displayed on the first channel as an additional image. The information on titles, genres, etc. of the program content may be included in the DCCT, but not limited thereto. Information included in the EIT may be used, too.

The controller 70 may control the display part 50 to display the first channel information thereon for predetermined periods of time, starting from the display point of time. For example, the display part 50 may display the first channel information for 10 seconds, from 15 seconds before the returning point of time. As an example of an exemplary embodiment of the present invention, the first channel information is displayed on the display part 50 for 10 seconds, but the present invention is not limited thereto. Alternatively, the first channel information may be displayed on the display part 50 longer or shorter as long as it is displayed before the returning point of time.

Meanwhile, the controller 70 may display alarm information 53, on the display part 50, to alarm that the channel goes back to the first channel soon while a viewer views the second channel by the DCC function, at the display point of time or after the display point of time. For example, the alarm information 53 may be displayed on the display part 50 for 3 seconds, from 15 seconds before the returning point of time. As an example of an exemplary embodiment of the present invention, the alarm information 53 is displayed on the display part 50 for 3 seconds, but the present invention is not limited thereto. Alternatively, the alarm information 53 may be displayed longer or shorter as long as it is displayed before the returning point of time.

If it is determined that a predetermined control signal is supplied while the second channel is displayed on the display part 50, the controller 70 may control the display part 50 to display the second channel continuously, without returning to the first channel even at the returning point of time. At this time, the controller 70 may enable only the control signal supplied while the first channel information is displayed.

For example, the controller 70 may control the channel not to return to the first channel even at the returning point of time if determined that the stop key is selected through the user input part 90 while the first channel information is displayed on the display part 50.

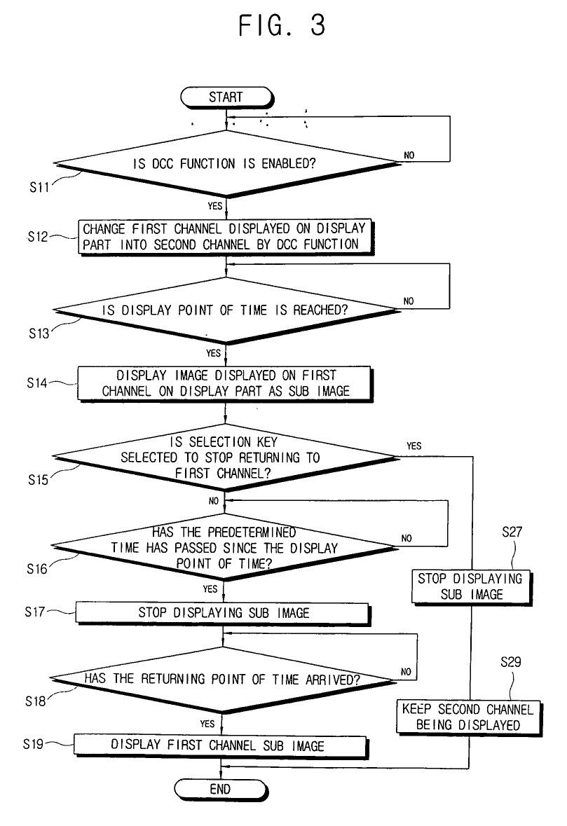

As shown in FIG. 3, in the digital broadcasting signal processing apparatus according to an exemplary embodiment of the present invention, the DCC function is enabled at operation S11. If the digital broadcasting signal processing apparatus receives the broadcast signal having the DCC function, the first channel displayed on the display part 50 is changed into the second channel at the changing point of time set in the DCCT, at operation S12, if the selection information of the DCCT conforms to the user information set by a viewer when a viewer views the predetermined first channel.

If reaching the display point of time which is ahead of predetermined time from the returning point of time at operation S13, the controller 70 may control the display part 50 to display the first channel information thereon. For example, the controller 70 may control the display part 50 to display the image displayed on the first channel as an additional image. At this time, the controller 70 may control the image displayed on the second channel to be displayed as the main image 51, the image displayed on the first channel as the sub image 52, at operation S14.

If receiving the signal that the stop key is selected to stop returning to the first channel while the first channel information is displayed on the display part 50 at operation S15, the controller 70 controls the display part 50 not to display the first channel information thereon at operation S27. Then, the digital broadcasting signal processing apparatus does not allow the first channel to come back even at the returning point of time, and displays the second channel on the display part 50 at operation 29 in a case that a user does not change the channel additionally.

Meanwhile, the controller 70 controls the display part 50 to display the first channel information thereon for predetermined periods of time at operation S16, and controls the display part 50 to stop displaying the first channel information at operation S17 if the stop key to stop returning to the first channel is not selected, at operation S15, while the first channel information is displayed on the display part 50.

If reaching the returning point of time at operation S18, the digital broadcasting signal processing apparatus according to the present invention displays the first channel on the display part 50 at operation S19.

As described above, the controller 70 may control the display part 50 to display the alarm information 53 thereon to alarm that the channel goes back to the first channel soon while a viewer views the second channel by the DCC function, at the display point of time or after the display point of time.

As described above, the digital broadcasting signal processing apparatus according to an exemplary embodiment of the present invention displays the original channel information on the display part 50 before the channel changed by the DCC function goes back to the original channel. Accordingly, a user may easily select whether to view the original channel, and may view the original channel with a simplified adjustment.

The display part 50 of the digital broadcasting signal processing apparatus according to an exemplary embodiment of the present invention is provided in the digital broadcasting signal processing apparatus, but the present invention is not limited thereto. Alternatively, the display part 50 may be provided as an additional device.

For example, if the digital broadcasting signal processing apparatus according to an exemplary embodiment of the present invention is provided as a set top box, the digital broadcasting signal processing apparatus may be separable to the display apparatus. Accordingly, the digital broadcasting signal processing apparatus does not comprise the display part. However, if the digital broadcasting signal processing apparatus according to the present invention is integrally provided in the display apparatus, the digital broadcasting signal processing apparatus comprises the display part 50.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A digital broadcasting signal processing apparatus having a direct channel change (DCC) function, comprising:
a signal processor; and
a controller to control the signal processor to output first channel information if a first channel is changed into a second channel by the DCC function.

2. The digital broadcasting signal processing apparatus according to claim 1, further comprising a display part,
wherein the signal processor outputs an image signal and the first channel information to the display part.

3. The digital broadcasting signal processing apparatus according to claim 2, further comprising a signal receiver to receive information on a changing point of time at which a channel displayed on the display part by the DCC function is changed from the first channel to the second channel, and information on a returning point of time at which the second channel displayed on the display part returns to the first channel, wherein the controller controls the first channel information at a display point of time which is ahead of predetermined time from the returning point of time to be displayed on the display part.

4. The digital broadcasting signal processing apparatus according to claim 3, wherein the signal receiver receives a direct channel change table (DCCT) comprising information on the changing point of time and the returning point of time.

5. The digital broadcasting signal processing apparatus according to claim 3, wherein the controller controls the signal processor to display an image displayed on the first channel at the display point of time, on a part of the display part.

6. The digital broadcasting signal processing apparatus according to claim 3, wherein the controller controls the first channel information displayed on the display part for predetermined periods of time starting from the display point of time.

7. The digital broadcasting signal processing apparatus according to claim 6, wherein the controller controls the image corresponding to the second channel displayed on the display part by a predetermined control signal even after the returning point of time.

8. The digital broadcasting signal processing apparatus according to claim 7, wherein the controller enables the control signal only when the first channel information is displayed on the display part.

9. The digital broadcasting signal processing apparatus according to claim 8, further comprising a user input part to generate the control signal.

10. The digital broadcasting signal processing apparatus according to claim 3, wherein the signal processor further comprises an interface generator to generate an interface image to notify a user that the channel displayed on the display part returns to the first channel if reaching the returning point of time, and the controller controls the interface generator to display the interface image on the display part before the predetermined time from the returning point of time.

11. A method of controlling a digital broadcasting signal processing apparatus having a direct channel change (DCC) function, comprising:
changing a first channel into a second channel by the DCC function; and
outputting first channel information.

12. The method according to claim 11, further comprising displaying the first channel information.

13. The method according to claim 12, further comprising receiving information on a changing point of time at which the first channel is changed into the second channel by the DCC function, and on a returning point of time at which the second channel is returned to the first channel,
wherein displaying the first channel information comprises displaying the first channel information on the display part at a display point of time which is ahead of predetermined time from the returning point of time.

14. The method according to claim 13, wherein the information on the changing point of time and the returning point of time is included in a direct channel change table (DCCT) to be received.

15. The method according to claim 13, wherein the displaying the first channel information comprises displaying an image displayed on the first channel at the display point of time, on a part of the display part.

16. The method according to claim 15, wherein the image displayed on the first channel is displayed on the part of the display part for predetermined periods of time starting from the display point of time.

17. The method according to claim 16, further comprising receiving a predetermined control signal and displaying the second channel on the display part by the control signal even after the returning point of time.

18. The method according to claim 17, wherein the control signal is enabled only when the image displayed on the first channel is displayed on the part of the display part.

19. The method according to claim 13, further comprising displaying an interface image on the display part to notify a user that the channel displayed on the display part returns to the first channel if reaching a returning point of time, before the predetermined time from the returning point of time.

20. A digital broadcasting signal processing apparatus, which supports a direct channel change function, comprising:
a display; and
a controller;
wherein, when the direct channel change function changes the display from a first channel to a second channel, the controller automatically switches the display back to the first channel after a predetermined period of time; and
wherein, before switching the display back to the first channel, information related to the first channel is displayed on a portion of the display.

21. The digital broadcasting signal processing apparatus according to claim 20, further comprising a stop key, which stops the display from switching back to the first channel.

22. The digital broadcasting signal processing apparatus of claim 20, wherein the information related to the first channel is at least one of an image of the first channel, the title of the program content of the first channel and the genre of the program content of the first channel.

23. The digital broadcasting signal processing apparatus of claim 20, wherein the information related to the first channel is related to the time at which the controller will switch the display back to the first channel.
